(19) United States
(12) Patent Application Publication
(10) Pub. No.: US 2002/0079363 A1
(43) Pub. Date: Jun. 27, 2002

(54) Social action system using a credit card

(75) Inventor: Hiroshi Sasabe, Hiroshima-shi (JP)

Correspondence Address: ARMSTRONG,WESTERMAN & HATTORI, LLP, 1725 K STREET, NW., SUITE 1000, WASHINGTON, DC, 20006, US

(73) Assignee: Kabushiki Kaisha West, Hiroshima-shi (JP)

(21) Appl. No.: 09/875,942

(22) Filed: Jun. 8, 2001

(30) Foreign Application Priority Data
Dec. 21, 2000 (JP) 2000-388584

(51) Int. Cl. G06K 5/00

(52) U.S. Cl. 235/380

(57) ABSTRACT

There has been a drawback that, when donation for organizations for a social action is attempted, an eagerness of making the donation is lost because of troublesomeness of investigation of a receiver's address or account or work of sending the money, and the organizations for the social action fall into short of funds. A social action system using a credit card wherein, when an individual 2 holding the credit card issued by a credit card issuer 1 that intends to contribute to the society uses the card at a store 3 and the like that handle the credit card, the sale proceeds of the store or the like are used for a social action.

### BACKGROUND OF THE INVENTION

Field of the Invention

The present invention relates to a social action system using a credit card wherein a credit card issuer or a credit card holder contributes to the society according to an amount of sale proceeds from merchandise or services purchased by a card member who holds the card issued and lent by the credit card issuer at a shop and the like that handle the card.

Concerning a prior-art credit card, when a card member purchases merchandise or services by use of a credit card from a shop such as a store that handles the credit card, the purchased price is paid for the shop by a credit card company, while a request related to the payment is made to the card member. Then, the card member makes the payment to a bank account of the credit card company or the payment is charged directly to a bank account of the card member.

On the other hand, it is systemized so that the credit card company can make a profit from a processing fee for the purchase, an interest for an installment plan, and other factors. Moreover, the credit card company pays back a part of the profit gained in this manner to a credit card issuer that issues the card by cash and the like, and by adopting such means, the credit card issuer or the credit card company has intended to expand the size of the company and increase the profit.

### SUMMARY OF THE INVENTION

In such a credit system using a conventional credit card, it has been intended to make a profit for a credit card company or a credit card issuer involved in the system. However, the profit has never been useful for a social action such as the environmental cleanup for the society, welfare for the aged, or medical improvement.

Moreover, organizations intended for the social action are usually unknown in general. Therefore, even if general public are prepared to make a donation to those organizations for the social action, a motivation of making the donation is lost because a receiver's address or account is unknown and checking it and sending the money are troublesome. Accordingly, there has been a drawback such that the organizations cannot act as they want because they are short of funds.

In the light of the above drawback, an object of the present invention is to provide a social action system using a credit card wherein a specific credit card issuer donates all of or a part of the profit such as the paid-back cash, or the card member donates a part of or all of the sum that is equivalent to points obtained in accordance with an amount of the card use as a part of costs of the organizations for the environmental cleanup, welfare for the aged, or medical improvement so that the donation helps those organizations take actions, and the use of the credit card can automatically be the social action.

Moreover, by using such a credit card, the card member can be proud of making the social action, and can feel pleasure that is different from an ordinary use of the credit card.

In order to accomplish the above-described object, the social action system using the credit card according to the present invention is that when an individual holding the credit card issued by a credit card issuer that intends to contribute to the society uses the card at a store that handles the credit card, the sales are used for a social action.

Moreover, the sale proceeds used for the social action are a part of or all of a money amount that is paid back by a credit card company to the credit card issuer in accordance with a money amount paid with the credit card.

Furthermore, it is also possible to systemize the system so that the sale proceeds used for the social action can be a part of or all of a money amount being in proportion to points that are returned to the individual using the credit card.

### BRIEF DESCRIPTION OF THE DRAWING

FIG. 1 is a block diagram of a social action system by using a credit card in the present invention.

### DESCRIPTION OF THE PREFERRED EMBODIMENT

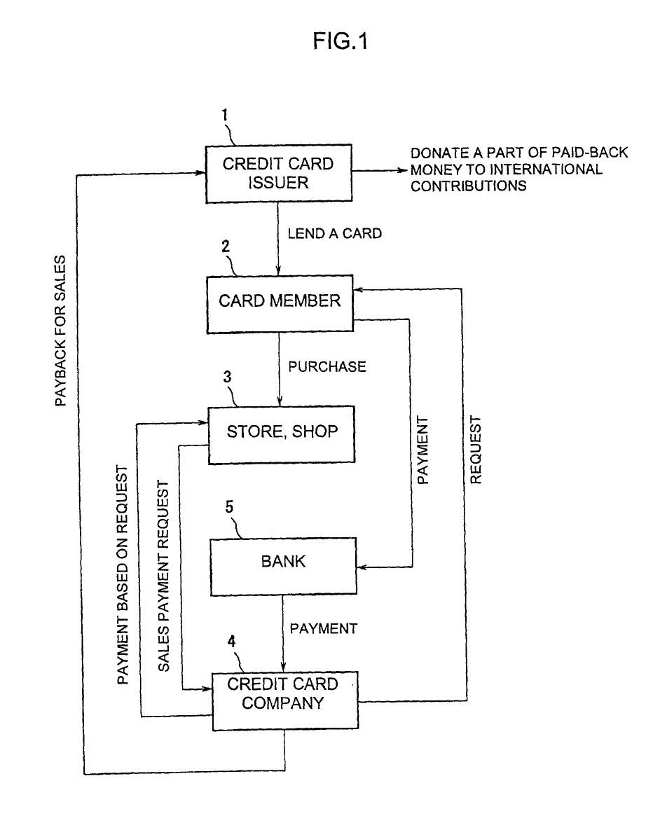

Next, a preferred embodiment of a social action system using a credit card according to the present invention will be explained below with reference to a system block diagram in FIG. 1.

A reference numeral 1 is a credit card issuer for issuing a credit card that intends to contribute to the society.

2 is a card member who is lent the credit card by the credit card issuer, 3 is a store or shop whereat the card member 2 purchases merchandise or receives services by using the credit card, 4 is a credit card company that has a contract with the credit card issuer, and 5 is a bank that makes a payment in the case where the payment for purchasing the merchandise or receiving the services by the card member is requested by the credit card company 4 and an automatic payment directly from the bank account is generally adopted.

Next, an explanation will be given of the social action system using the credit card with reference to the system block diagram.

When the card member 2 who is lent the card by the credit card issuer 1 purchases the merchandise or the services, the store or shop 3 whereat the purchase is taken place requests the payment to the credit card company 4.

Besides, the system is designed so that, when the card member purchases the merchandise or the services, the store or shop can investigate the credit on whether or not the card used by the card member is improperly used (it is expired, it is subjected to a robbery report, etc.) by checking to the credit card company 4 through a phone line, and a card settlement can be implemented only when it is confirmed that the card is not used improperly.

The credit card company 4 makes the payment for the request from the store or shop while making a request based on the purchase to the card member 2, and the card member 2 makes the payment to the bank 5 on the basis of the request, or the payment is charged directly to the bank account of the card member 2.

Then, the bank 5 pays the money amount used by the card member 2 to the credit card company 4 in order to make the payment of the purchase by using the credit card. Moreover, for such sale proceeds, it is systemized that the credit card company pays back a part of the sale proceeds to the credit card issuer.

Although the system using the credit card that is well known has been explained as above, in the present invention, the credit card issuer 1 that intends to contribute to the society donates all of such paid-back money or a money amount based on a fixed rate to the organizations intended for an international social action so that the purchase by the card member 2 can be useful for the social action by the donation.

As an example of the organizations for the social action, there can be mentioned the AMDA (Association of Medical Doctor of Asia) of NGO, which medically contributes to the society by using such donation as a part of their activity funds.

Moreover, a certain kind of credit card issuer has a system where points are returned to the card member 2 in accordance with the money amount spent by the credit card of the card member, and the cardmember2 can receive various kinds of goods, services, and the like based on the points.

On the other hand, the preferred embodiment has a system where, with a previous agreement on the abandonment of all of or a part of the points obtained by the card member 2, all of or a part of the points are converted into a money amount, and the credit card issuer 1 donates the money to the organizations for the social action such as the ones mentioned above so that the donation can be useful for more social action.

As described above, in the present invention, when a card member holding a credit card issued by a credit card issuer that intends to contribute to the society purchases merchandise or services with the credit card, money that corresponds to a spent money amount is donated to organizations for a social action.

Moreover, the purchase of the merchandise or services by using the credit card can contribute to the society since the organizations for the social action can take action by using the donated money as a part of their activity funds, and the contribution to the society is accomplished by that. Therefore, the social action can be accomplished by using the credit card without taking trouble for checking the organizations for the social action, checking their addresses or accounts, and sending money like in a conventional way of donating money to the social action. That is to say, the social action can easily be accomplished since there is no need for troublesome work as described above.

Accordingly, the present invention has effects such that many profits can be obtained, for example, the card member can obtain pleasure and satisfaction from the social action by using the credit card while affluent social environment can be acquired since the activity funds of the organizations for the social action increases, and their activities become more active.

What is claimed is:

1. A social action system using a credit card wherein, when an individual holding a credit card issued by a credit card issuer that intends to contribute to the society uses the card at a store and the like that handle the credit card, the sale proceeds of the store are used for a social action.

2. A social action system using a credit card according to claim 1 wherein said sale proceeds used for the social action are a part of or all of a money amount that is paid back by a credit card company to the credit card issuer in accordance with a money amount paid with said credit card.

3. A social action system using a credit card according to claim 1 wherein said sale proceeds used for the social action are a part of or all of a money amount being in proportion to points that are returned to the individual using said credit card.
